(19) United States
(12) Patent Application Publication
(10) Pub. No.: US 2024/0136504 A1
(43) Pub. Date: Apr. 25, 2024

(54) ANODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Jeong A KIM, Daejeon (KR); Yong Seok LEE, Daejeon (KR); Jae Ram KIM, Daejeon (KR)

(21) Appl. No.: 18/452,558

(22) Filed: Aug. 20, 2023

(30) Foreign Application Priority Data
Oct. 20, 2022 (KR) 10-2022-0136243

(51) Int. Cl. H01M 4/36; H01M 4/04; H01M 4/38; H01M 4/583; H01M 10/052

(52) U.S. Cl. CPC H01M 4/364; H01M 4/0404; H01M 4/386; H01M 4/583; H01M 10/052; H01M 2004/027

(57) ABSTRACT

An anode for a lithium secondary battery includes a anode current collector, a first anode mixture layer disposed on at least one surface of the anode current collector and including a first carbon-based active material and a silicon-based active material including a porous structure, and a second anode mixture layer disposed on the first anode mixture layer and including a second carbon-based active material and a silicon-based active material doped with magnesium.

### CROSS-REFERENCE TO RELATED APPLICATION(S)

This patent document claims the priority and benefits of Korean Patent Application No. 10-2022-0136243 filed on Oct. 21, 2022, the disclosure of which is incorporated herein by reference in its entirety.

### TECHNICAL FIELD

The technology and implementations disclosed in this patent document generally relate to an anode for a lithium secondary battery and a lithium secondary battery including the same, and more particularly, to an anode for a high-capacity secondary battery having a multilayer structure and having excellent rapid charging characteristics and the like, and a lithium secondary battery including the same.

### BACKGROUND

Recently, a lot of research has been conducted on electric vehicles (EVs) that may replace vehicles using fossil fuels, such as gasoline vehicles and diesel vehicles, which may be main causes of air pollution. A lithium secondary battery having a high discharge voltage and output stability is mainly used as a power source of such an electric vehicle (EV). Accordingly, to this end, the need for a lithium secondary battery having high energy density is increasing, and development of and research into high-capacity anodes are also being actively conducted.

To implement a secondary battery with high capacity and high energy density, development of applying a silicon-based active material having a higher discharge capacity than graphite to an anode for a secondary battery is actively being conducted. When such a silicon-based active material having a high discharge capacity is applied together with a carbon-based active material such as graphite, since the loading weight (LW) of the anode mixture layer may also be lowered, the energy density may be further increased.

However, in the case of silicon-based active materials, the lithium ion diffusion rate is slower than a diffusion rate of carbon-based active materials and has a high volume expansion rate, and thus, there is a difficulty in securing a high level of rapid charging characteristics, lifespan characteristics, and the like of an anode including a silicon-based active material. Accordingly, there is a need to develop an anode for a secondary battery having excellent capacity characteristics, rapid charging characteristics, lifespan characteristics, and the like.

### SUMMARY

The disclosed technology may be implemented in some embodiments to provide an anode having high capacity and high energy density while mitigating volume expansion of the anode.

In addition, the disclosed technology may be implemented in some embodiments to provide an anode for a lithium secondary battery with improved rapid charging performance.

Furthermore, the disclosed technology may be implemented in some embodiments to provide a lithium secondary battery including an anode as described above.

In some embodiments of the disclosed technology, an anode for a lithium secondary battery includes an anode current collector; a first anode mixture layer disposed on at least one surface of the anode current collector and including a first carbon-based active material and a silicon-based active material including a porous structure; and a second anode mixture layer disposed on the first anode mixture layer and including a second carbon-based active material and a silicon-based active material doped with magnesium. The porous structure includes carbon-based particles including pores and a silicon-containing coating disposed inside of the pores of the carbon-based particles or on surfaces of the carbon-based particles.

The silicon-based active material of the first anode mixture layer may include a Si—C composite.

The silicon-based active material of the second anode mixture layer may include SiOₓ (0<x<2).

The first carbon-based active material and the second carbon-based active material may be, independently, at least one selected from the group consisting of natural graphite, artificial graphite, graphitized carbon fibers, graphitized mesocarbon microbeads, and amorphous carbon.

A weight ratio of the silicon-based active material and the first carbon-based active material included in the first anode mixture layer may be 1:5 to 20.

A weight ratio of the silicon-based active material and the second carbon-based active material included in the second anode mixture layer may be 1:4 to 16.

A thickness ratio of the first anode mixture layer and the second anode mixture layer may be 1:1 to 1.25.

At least one of silicon-based active materials of the first anode mixture layer and the second anode mixture layer may have a carbon coating layer disposed on an outermost portion.

In some embodiments of the disclosed technology, a lithium secondary battery includes the anode described above and a cathode disposed to face the anode.

### BRIEF DESCRIPTION OF DRAWINGS

Certain aspects, features, and advantages of the disclosed technology are illustrated by the following detailed description with reference to the accompanying drawings.

FIG. 1 is a schematic cross-sectional view illustrating the structure of an anode for a secondary battery according to an embodiment.

FIG. 2 is a graph illustrating rapid charge lifespan characteristics according to the type of silicon-based active material.

FIG. 3 is a graph illustrating normal (room temperature) lifetime characteristics according to the type of silicon-based active material.

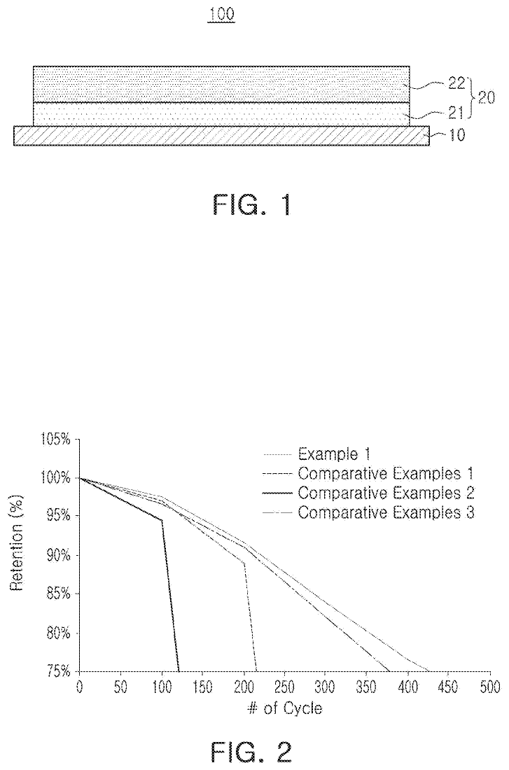

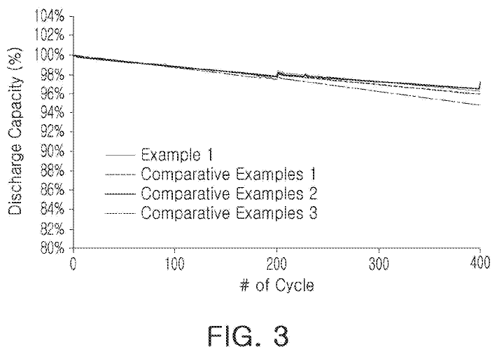

### DETAILED DESCRIPTION

Features of the disclosed technology disclosed in this patent document are described by example embodiments with reference to the accompanying drawings.

Hereinafter, example embodiments of the disclosed technology will be described. However, the embodiments of the disclosed technology may be modified in many different forms, and the scope of the disclosed technology is not limited to the embodiments described below.

In addition, in this specification, singular expressions include plural expressions unless the context clearly indicates otherwise, and throughout the specification, the same reference numerals or reference numerals assigned in a similar manner shall refer to the same or corresponding components.

In general, as a method for improving the rapid charging characteristics of a lithium secondary battery, by reducing the loading amount of the anode active material or the rolling density of the anode, charging may be performed at a relatively high charging rate by increasing the porosity of the anode such that ions and/or electrons may move smoothly.

However, as described above, when the loading amount or rolling density is reduced, it may be difficult to obtain a high-capacity battery due to the difficulty in densifying the anode, and adhesion between the anode mixture layer and the anode current collector may decrease, and lifespan characteristics may be deteriorated.

In addition, as described above, the silicon-based active material included to increase the capacity of the anode for a secondary battery generally has a slow lithium ion diffusion rate compared to the carbon-based active material, and thus may have relatively poor fast charging characteristics.

Accordingly, the inventors of the disclosed technology confirmed that the above problems may be substantially resolved when different silicon-based active materials are applied to respective layers in the anode of the ‘multilayer structure.’ Referring to FIG. 1, embodiments of the disclosed technology will be described in detail below.

FIG. 1 is a schematic cross-sectional view illustrating a structure of an anode for a secondary battery according to an embodiment.

An anode 100 for a lithium secondary battery according to an embodiment includes an anode current collector 10 and an anode mixture layer 20 disposed on the anode current collector 10.

The anode current collector 10 may include a metal that has high conductivity, improved adhesion to the anode slurry, and is not reactive within a voltage range of a secondary battery. For example, the anode current collector may include copper, stainless steel, nickel, titanium, or alloys thereof. The anode current collector 10 may include copper or stainless steel surface-treated with carbon, nickel, titanium, or silver.

The anode mixture layer 20 including a silicon-based active material and a carbon-based active material is disposed on at least one surface of the anode current collector 10. The anode mixture layer 20 may be coated on the upper and lower surfaces of the anode current collector 10, respectively. The anode mixture layer 20 may directly contact the surface of the anode current collector 10.

According to an embodiment, the anode mixture layer has a multilayer structure including a first anode mixture layer 21 disposed on the anode current collector 10 side with respect to one surface of the anode current collector, and a second anode mixture layer 22 disposed on a surface side. The first anode mixture layer 21 may be directly disposed on the surface of the anode current collector 10, and the second anode mixture layer 22 may be directly disposed on the surface of the first anode mixture layer 21.

The first anode mixture layer 21 and the second anode mixture layer 22 include a carbon-based active material and a silicon-based active material, respectively, but the first anode mixture layer and the second anode mixture layer include independent silicon-based anode active materials.

The silicon-based active material of the first anode mixture layer 21 of the disclosed technology is a silicon-based active material including a porous structure, and in detail, may include a silicon carbide-based active material such as a Si—C composite, which is a compound represented by the chemical formula of SiC. The porous structure is a structure including carbon-based particles including pores and a silicon-containing coating disposed inside the pores of the carbon-based particles and/or on the surface of the carbon-based particles.

The Si—C composite has characteristics of high capacity and low resistance as compared to existing silicon oxide-based active materials. In addition, since in the Si—C composite, silicon is present in a structure similar to graphite, a phenomenon of electrode cracks caused by volume expansion of an active material containing a silicon-based oxide may be alleviated, and conductivity may be secured. By applying the first anode mixture layer 21 including the Si—C composite to the lower layer, resistance generated between the anode current collector 10 and the anode mixture layer may be significantly reduced, which may have an advantageous effect on cell performance such as rapid charging and the like.

A weight ratio of the silicon-based active material and the first carbon-based active material included in the first anode mixture layer 21 may be 1:5 to 20, in detail, 1:7 to 17. Within the above range, the degradation of the high-temperature lifespan characteristics may be suppressed while the rapid charging characteristics and room temperature lifespan characteristics of the battery are improved.

The second anode mixture layer 22 includes a magnesium-doped silicon-based active material and a second carbon-based active material.

The silicon-based active material of the second anode mixture layer 22 may include SiOₓ (0<x<2). In general, as the x value decreases, the battery capacity increases and battery lifespan decreases, and as the x value increases, the battery capacity decreases and the energy density of the electrode decreases. Therefore, in the disclosed technology, by providing the x in the above range, the energy density may be secured while securing the capacity of the battery.

The silicon-based active material may further include a carbon coating layer disposed on the particles. Accordingly, contact of the silicon-based active material particles with moisture in the air and/or water in the anode slurry may be prevented. Therefore, a decrease in the discharge capacity of the secondary battery may be suppressed.

For example, the carbon coating layer may be at least one selected from the group consisting of amorphous carbon, carbon nanotubes, carbon nanofibers, graphite, graphene, graphene oxide, and reduced graphene oxide.

A carbon coating layer may be disposed on an outermost portion of at least one of the silicon-based active material of the first anode mixture layer 21 and the silicon-based active material of the second anode mixture layer 22.

The silicon-based active material includes magnesium doping, and the magnesium-doped silicon-based active material may include micropores. Accordingly, swelling of the silicon-based active material may be reduced during charging and discharging, thereby suppressing cracks of the active material including the silicon-based oxide during charging and discharging. In this case, the rapid charge lifespan characteristics of lithium secondary batteries and cycle characteristics thereof at room temperature may be improved, but due to irreversible side reactions, high-temperature lifespan characteristics may be deteriorated.

In this regard, in the disclosed technology, the first anode mixture layer 21 including a silicon-based active material that is not doped with magnesium and includes a porous structure is positioned as a lower layer, and the second anode mixture layer 22 including the magnesium-doped silicon-based active material is positioned as an upper layer. Therefore, the silicon-based active material including the porous structure located in the lower layer relieves the occurrence of electrode cracks due to the volume expansion of the silicon-based active material doped with magnesium located in the upper layer and maintains conductivity, thereby preventing distortion of the electrode structure, and simultaneously obtaining effects of improving not only general lifespan characteristics but also rapid charge lifespan characteristics and cycle characteristics at room temperature by the silicon-based active material doped with magnesium, located as the upper layer.

The silicon-based active material may be formed by mixing, heating, cooling, and pulverizing a silicon-based active material and a magnesium source. The magnesium source may be solid magnesium. In addition, a mixture may be prepared by mixing the silicon-based active material and the magnesium source.

The content of the magnesium source relative to the total weight of the mixture may be 5 to 17% by weight. Within this range, deterioration in capacity characteristics of a secondary battery due to an excessive decrease in silicon content may be prevented while the silicon-based active material is doped with a sufficient amount of magnesium.

The Mg1s spectrum of the surface of the magnesium-doped silicon-based active material measured through X-ray photoelectron spectroscopy (XPS) may satisfy the following equation 1.

P_{Mg}/(P_{Mg}+P_{MgO})≤0.6 [Equation 1]

In Equation 1, P_{Mg} is the area of the 1303 eV peak of the Mg1s spectrum, and P_{MgO} is the area of the 1304.5 eV peak of the Mg1s spectrum.

The P_{Mg} is the area of the peak (1303 eV) representing the magnesium element, and P_{MgO} is the area of the peak (1304.5 eV) representing the combination of the magnesium element and the oxygen element.

For example, the P_{Mg}/(P_{Mg}+P_{MgO}) value in Equation 1 may represent the ratio of magnesium metal among magnesium metal, magnesium oxide, and magnesium hydroxide present on the surface of a magnesium-doped silicon-based active material.

In the XPS spectrum that satisfies Equation 1, side reactions caused by conversion of magnesium remaining on the surface of the magnesium-doped silicon-based active material to magnesium hydroxide may be suppressed. Accordingly, deterioration in the lifespan characteristics of the lithium secondary battery may be prevented.

The mixture may be calcined at a temperature of 1000 to 1800° C. and then cooled to precipitate a silicon oxide composite containing magnesium. A silicon-based active material doped with magnesium may be prepared by crushing and classifying the silicon oxide composite containing magnesium.

A weight ratio of the silicon-based active material and the second carbon-based active material included in the second anode mixture layer 22 may be 1:4 to 16, in detail, 1:7 to 12. Within the above range, the degradation of the high-temperature lifespan characteristics may be suppressed while the rapid charging characteristics and room temperature lifespan characteristics of the battery are improved.

A silicon-based active material including the porous structure may be doped with a metal other than magnesium. The silicon-based active material including the porous structure may be doped with at least one metal selected from the group consisting of Li, Al, Ca, Fe, Ti, and V. Accordingly, the conductivity and/or structural stability of the silicon-based active material including the porous structure may be improved.

When only natural graphite is used as an anode active material, for example, adhesion to an anode current collector is excellent, but resistance increases during rapid charging and discharging, and thus output characteristics may deteriorate. In addition, natural graphite is damaged due to the expansion of the silicon-based active material, and thus the mobility of lithium ions may be reduced. Accordingly, side reactions may occur at the anode and lifespan characteristics may be deteriorated.

In the case of each of the first carbon-based active material and the second carbon-based active material, the carbon-based material may be one selected from natural graphite, artificial graphite, carbon black, acetylene black, Ketjen black, amorphous carbon fine powder, coke powder, meso-phase carbon, vapor-phase grown carbon fiber, pitch-based carbon fiber, polyacrylonitrile-based carbon fiber, and combinations thereof, and in addition, may be obtained by carbonization from a precursor of sucrose, phenol resin, naphthalene resin, polyvinyl alcohol, furfuryl alcohol resin, polyacrylonitrile resin, polyamide resin, furan resin, cellulose resin, styrene resin, polyimide resin, epoxy resin, vinyl chloride resin, citric acid, stearic acid, polyfluorovinylidene, carboxymethylcellulose (CMC), hydroxypropylcellulose, polyvinylpyrrolidone, tetrafluoroethylene, polyethylene, polypropylene, ethylene-propylene-diene Monomer (EPDM), sulfonated EPDM, starch, glucose, gelatin, saccharide, coal-based pitch, petroleum-based pitch, polyvinyl chloride, mesophase pitch, tar, low molecular weight heavy oil, and combinations thereof, and in detail, may include artificial graphite and/or natural graphite. Accordingly, the adhesion between the anode current collector 10 and the anode mixture layer 20 and the output characteristics of the secondary battery may be improved together.

The first carbon-based active material and the second carbon-based active material may include the same carbon-based active material, or may include different carbon-based active materials.

The first anode mixture layer 21 may be manufactured by coating, drying, and rolling a first carbon-based active material and a silicon-based active material including a porous structure on the anode current collector 10.

The second anode mixture layer 22 may be manufactured by coating, drying, and rolling a second carbon-based active material and a silicon-based active material coated with magnesium on the anode current collector 10.

In the first anode mixture layer 21, an anode binder, a conductive material, and/or a dispersing material, as well as a first carbon-based active material and a silicon-based active material including a porous structure, may be mixed.

In the second anode mixture layer 22, an anode binder, a conductive material, and/or a dispersing material, as well as a second carbon-based active material and a silicon-based active material coated with magnesium may be mixed.

The binder is a compound that serves to appropriately attach ingredients in the anode mixture layer 20 to each other and appropriately attach the anode mixture layer 20 to the current collector, and may be at least one rubber-based binder selected from the group consisting of styrene-butadiene rubber (SBR), fluorine-based rubber, ethylene propylene rubber, butyl acrylate rubber, butadiene rubber, isoprene rubber, acrylonitrile rubber, acrylic rubber, and silane-based rubber; a cellulosic binder such as carboxymethylcellulose (CMC), hydroxypropylmethylcellulose, methylcellulose, or alkali metal salts thereof; a water-soluble polymer-based binder such as polyacrylic acid (PAA)-based binders, polyvinyl alcohol (PVA)-based binders, and polyvinyl alcohol-polyacrylic acid copolymer (PVA-PAA Copolymer)-based binders; and combinations thereof. In detail, each of the first anode mixture layer and the second anode mixture layer may further include a rubber-based binder. In more detail, the first anode mixture layer 21 and the second anode mixture layer 22 may independently further include a rubber-based binder and a cellulose-based binder.

The conductive material imparts conductivity to the electrode and is used for maintaining the structure of the electrode and the like, and may have conductivity without causing side reactions with other elements of the secondary battery. As an example, the conductive material may be graphite such as natural graphite and artificial graphite; carbon-based materials such as carbon black, acetylene black, ketjen black, channel black, furnace black, lamp black, thermal black, and carbon fiber; metal powders or metal fibers such as copper, nickel, aluminum, and silver; conductive whiskers such as zinc oxide and potassium titanate; conductive metal oxides such as titanium oxide; conductive polymers such as polyphenylene derivatives, or the like, and one thereof alone or a mixture of two or more thereof may be used. In detail, the conductive material may include carbon nanotubes (CNT). Carbon nanotubes (CNTs) may have higher electron mobility than carbon black or the like, which is an existing conductive material, implement high energy density with a relatively small amount, have relatively high strength and the like due to a stable structure thereof, and alleviate volume expansion of the silicon-based active material. Therefore, when the conductive material includes carbon nanotubes (CNT), the energy density, lifespan characteristics, and resistance characteristics of the electrode may be further improved.

As the dispersing material, a CMC-based dispersing material may be used as a carbon nanotube dispersing material.

### MANUFACTURING EXAMPLE

(1) Manufacture of Anode

1) Preparation of First Anode Mixture Layer

By adding water to 80.05 wt % of artificial graphite (D50: 20 μm) as a carbon-based active material, 16.00 wt % of SiC as a silicon-based active material containing a porous structure, 0.25 wt % of SWCNT conductive material, and 3.7 wt % of CMC/SBR (binder, 1.30/2.40 weight ratio), a first anode mixture layer composition in the form of a slurry was prepared.

2) Preparation of Silicon-Based Active Material Doped with Magnesium

As a silicon-based active material, silicon oxide (SiOₓ, 0<x<2, D50: 6 μm) was added and mixed with magnesium in an amount corresponding to 8% by weight relative to the total weight of the silicon-based active material to prepare a silicon-based active material doped with magnesium.

In detail, a mixture was prepared by mixing silicon and SiO₂ at a ratio of 1:1 and mixing 8% by weight of magnesium based on the total weight of the magnesium-doped silicon-based active material together with silicon and SiO₂.

The mixture was calcined at 1500° C. and then cooled to precipitate a silicon oxide composite containing magnesium. The precipitated silicon oxide composite was pulverized and classified to prepare a magnesium-doped silicon-based active material.

3) Preparation of Second Anode Mixture Layer

By adding water to 80.05% by weight of artificial graphite (D50: 20 μm) as a carbon-based active material, 16.00% by weight of the prepared silicon-based active material doped with magnesium, 0.25% by weight of SWCNT conductive material, and the solid content of 3.7% by weight of CMC/SBR (binder, 1.30/2.40 weight ratio), a second anode mixture layer composition in the form of a slurry was prepared.

(2) Manufacture of Lithium Secondary Battery

An anode was prepared by applying the prepared first anode mixture layer and the second anode mixture layer differently as illustrated in Table 1 below.

A slurry was prepared by mixing Li[Ni_{0.88}Co_{0.1}Mn_{0.02}]O₂ as a cathode active material, MWCNTs as a conductive material, and polyvinylidene fluoride (PVdF) as a binder in a weight ratio of 98.08:0.72:1.2. The slurry was uniformly applied to an aluminum foil having a thickness of 12 μm and was vacuum dried to prepare an anode for a secondary battery. At this time, about 20% by weight of the MWCNT content was composed of the CNT dispersing material.

The cathode and the anode were laminated by notching to a predetermined size, and an electrode cell was prepared by interposing a separator (polyethylene, thickness 13 μm) between the cathode and anode, and then the tabs of the cathode and anode were welded, respectively. The welded cathode/separator/anode assembly was placed in a pouch and sealed on three sides except for the electrolyte injection side. At this time, the part with the electrode tab was included in the sealing part.

Electrolyte was injected through the remaining side except for the sealing part, and after sealing the remaining side, it was impregnated for 12 hours or more.

The electrolyte was prepared by dissolving 1.1M LiPF6 in a mixed solvent of EC/EMC (25/75; volume ratio) and then adding 8% by weight of fluoroethylene carbonate (FEC), 0.5% by weight of 1,3-propensultone (PRS) and 1.0% by weight of 1,3-propanesultone (PS).

Thereafter, heat press precharging was performed for 60 minutes with a current corresponding to an average of 0.5 C. After stabilization for 12 hours or more, degassing was performed, and after aging for 24 hours or more, chemical charging and discharging were performed. (Charging condition CC-CV 0.25 C 4.2V 0.05CCUT-OFF, discharging condition CC 0.25 C 2.5V CUTOFF).

Then, standard charging and discharging were performed (charging condition CC-CV 0.33 C 4.2V0.05 C CUT-OFF, discharging condition CC 0.33 C 2.5V CUT-OFF).

TABLE 1

| | | Thickness |
|---|---|---|
| | | ratio of upper |
| | | and lower |
| | Anode Structure | layers |
| Example 1 | Upper layer: second | 1 |
| | anode mixture layer | |
| | Lower layer: first | 1 |
| | anode mixture layer | |
| Comparative | Upper layer: first | 1 |
| Example 1 | anode mixture layer | |
| | Lower layer: second | 1 |
| | anode mixture layer | |
| Comparative | First anode mixture | — |
| Example 2 | layer alone | |
| Comparative | Second anode mixture | — |
| Example 3 | layer alone | |

Evaluation Example: Evaluation of Lifespan Characteristics of Rapid Charging and Evaluation of General (Room Temperature) Lifespan Characteristics

(1) Evaluation of Quick Charge Lifetime Performance

Lithium secondary batteries manufactured according to Example 1 and Comparative Examples 1 to 3 were charged to reach DOD72 within 35 minutes according to the step charging method at the C-rate of 3.25 C/3.0 C/2.75 C/2.5 C/2.25 C/2.0 C/1.75 C/1.5 C/1.25 C/1.0 C/0.75 C/0.5 C, and were then discharged at 1/3 C. The rapid charging evaluation was performed by repeating the charging and discharging cycle as one cycle. After repeating 300 cycles with a standby time of 10 minutes between charge and discharge cycles, the rapid charge capacity retention rate was measured.

(2) Evaluation of General (Room Temperature) Lifetime Performance

Lithium secondary batteries manufactured according to Example 1 and Comparative Examples 1 to 3 were evaluated for general charge lifespan characteristics in the range of DOD94 (SOC4-98) in a chamber maintained at 25° C. Under constant current/constant voltage (CC/CV) conditions, it was charged at 0.3 C to the voltage corresponding to SOC98, then cut off at 0.05 C, and then discharged at 0.3 C to the voltage corresponding to SOC4 under constant current (CC) conditions, and then, the discharge capacity thereof was measured. After repeating this for 500 cycles, the discharge capacity retention rate of general (room temperature) lifespan characteristics evaluation was measured.

(3) Energy Density Measurement

Wh/L measurement may be obtained directly from the normal charge/discharger data and may be obtained by a calculation value by dividing the capacity (Ah)×average voltage (v) by the cell volume.

TABLE 2

| | Rapid charge | Room temperature | |
|---|---|---|---|
| | lifespan capacity | lifespan capacity | Energy |
| | retention rate | retention rate | Density |
| | (300 Cycles, %) | (300 Cycles, %) | (Wh/L) |
| Example 1 | 84 | 97.0 | 775 |
| Comparative | Plummet after | 97.0 | 775 |
| Example 1 | 88.8%@200 cyc | | |
| Comparative | Plummet after | 97.2 | 775 |
| Example 2 | 94.4%@100 cyc | | |
| Comparative | 82.1 | 96.2 | 775 |
| Example 3 | | | |

According to Table 2, the lithium secondary battery of Example 1 including the first anode mixture layer in the lower layer and the second anode mixture layer in the upper layer exhibited improved rapid charge lifespan characteristics and general lifespan characteristics, as compared to Comparative Examples.

In detail, it can be seen that the same anode mixture layer as in Example 1 was used, but when the upper and lower layers were reversed (Comparative Example 1), the rapid charge lifespan rapidly decreased after 200 cyc.

In addition, it can be confirmed that when the anode mixture layer doped with magnesium is not included (Comparative Example 2), the rapid charge lifespan rapidly drops after 100 cyc.

Furthermore, when an anode mixture layer doped with magnesium is used, but the anode mixture layer having a multilayer structure is not included (Comparative Example 3), it can be confirmed that the rapid charging lifespan characteristics and general lifespan characteristics were lowered as compared to the secondary battery of Example 1.

As set forth above, according to an embodiment, an anode for a lithium secondary battery having improved high-capacity and high-energy density design while mitigating volume expansion of the anode, and simultaneously having improved fast charging performance, and a lithium secondary battery including the same.

Only specific examples of implementations of certain embodiments are described. Variations, improvements and enhancements of the disclosed embodiments and other embodiments may be made based on the disclosure of this patent document.

What is claimed is:

1. An anode for a lithium secondary battery, comprising:
an anode current collector;
a first anode mixture layer disposed on at least one surface of the anode current collector and including a first carbon-based active material and a silicon-based active material including a porous structure; and
a second anode mixture layer disposed on the first anode mixture layer and including a second carbon-based active material and a silicon-based active material doped with magnesium,
wherein the porous structure includes carbon-based particles including pores and a silicon-containing coating disposed inside of the pores of the carbon-based particles or on surfaces of the carbon-based particles.

2. The anode for a lithium secondary battery of claim 1, wherein the silicon-based active material of the first anode mixture layer includes a Si—C composite.

3. The anode for a lithium secondary battery of claim 1, wherein the silicon-based active material of the second anode mixture layer includes SiOₓ (0<x<2).

4. The anode for a lithium secondary battery of claim 1, wherein the first carbon-based active material and the second carbon-based active material are, independently, at least one selected from the group consisting of natural graphite, artificial graphite, graphitized carbon fibers, graphitized mesocarbon microbeads, and amorphous carbon.

5. The anode for a lithium secondary battery of claim 1, wherein a weight ratio of the silicon-based active material and the first carbon-based active material included in the first anode mixture layer is 1:5 to 20.

6. The anode for a lithium secondary battery of claim 1, wherein a weight ratio of the silicon-based active material and the second carbon-based active material included in the second anode mixture layer is 1:4 to 16.

7. The anode for a lithium secondary battery of claim 1, wherein a thickness ratio of the first anode mixture layer and the second anode mixture layer is 1:1 to 1.25.

8. The anode for a lithium secondary battery of claim 1, wherein at least one of silicon-based active materials of the second anode mixture layer has a carbon coating layer disposed on an outermost portion.

9. A lithium secondary battery comprising:
the anode according to claim 1; and
a cathode disposed to face the anode.
